(19) United States
(12) Patent Application Publication
(10) Pub. No.: US 2007/0156560 A1
(43) Pub. Date: Jul. 5, 2007

(54) Multiple Fixed Rate Distribution Schedules From A Single Investment Strategy Model

(75) Inventor: Keith Bayley Diffenderffer, Chula Vista, CA (US)

Correspondence Address: KEITH B. DIFFENDERFFER, 524 REISLING, CHULA VISTA, CA, 91913, US

(73) Assignee: Keith Bayley Diffenderffer, Chula Vista, CA (US)

(21) Appl. No.: 11/535,650

(22) Filed: Sep. 27, 2006

Related U.S. Application Data
(60) Provisional application No. 60/596,489, filed on Sep. 28, 2005.

(51) Int. Cl. G06Q 40/00

(52) U.S. Cl. 705/36 R

(57) ABSTRACT

The Multiple Fixed Rate Distribution Schedules From a Single Investment Strategy Model allows an investment firm to establish a portfolio based on an investment strategy and then offer a menu of different distribution rate choices from that portfolio.

This application should be cross-referenced to USPTO Provisional Utility Patent Application______; The Defined Fixed Percentage Rate Distribution Schedule for Open End Mutual Funds.

The Multiple Fixed Rate Distribution Schedules from a Single Investment Strategy Model allows an investment company to establish an investment strategy model and then attach more than one distribution schedule to that model. The portfolio manager creates a core portfolio according to the strategy model but then individualizes each fund based on the prospectus mandated distribution rate. Investors select an appropriate distribution percentage rate to meet their individual income requirements from a menu of distribution rate choices while at the same time addressing long-term portfolio optimization and personal risk tolerance. The investor will choose the investment strategy model that satisfies his/her investment criteria and then chooses the fund with the distribution percentage rate from that portfolio that satisfies his/her income requirements.

What is claimed is:

1. The Multiple Fixed Rate Distribution Schedules From a Single Investment Strategy Model recognizes that the professionally managed investment portfolio model was created as an asset accumulation vehicle and does not efficiently function as an asset distribution vehicle as currently structured. Nobel Prize winning research establishes the value of asset diversification and equity participation to achieve portfolio optimization.
Dividend distribution and income recognition regulations are structured to give preferential treatment to fixed income portfolios even though research proves that on an inflation adjusted basis fixed income based portfolios under-perform equity based portfolios. The Multiple Fixed Rate Distribution Schedules From a Single Investment Strategy Model allows investors to satisfy individual income requirements from equity based portfolios. Investor A. selects an investment portfolio that satisfies his/her investment criteria and distributes 4% of net-asset value annually; investor B. selects the same investment strategy portfolio but, chooses to receive a distribution of 6% of net asset value annually. Utilizing the same investment strategy Investor .A. chooses to exchange a lower current cash flow for greater future asset growth; Investor .B. chooses to exchange greater future asset growth for higher current cash flow. The Multiple Fixed Rate Distribution Schedule From a Single Investment Strategy Model represents a significant enhancement for providing investment income to the current model which focuses on the distribution of interest and dividends and is therefore subject to over dependence on fixed income instruments regardless of their appropriateness to prevailing economic conditions.
